(19) United States
(12) Patent Application Publication
(10) Pub. No.: US 2010/0037023 A1
(43) Pub. Date: Feb. 11, 2010

(54) SYSTEM AND METHOD FOR TRANSFERRING DATA BETWEEN DIFFERENT RAID DATA STORAGE TYPES FOR CURRENT DATA AND REPLAY DATA

(76) Inventors: Lawrence E. Aszmann, Prior Lake, MN (US); Michael J. Klemm, Minnetonka, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 12/537,408

(22) Filed: Aug. 7, 2009

Related U.S. Application Data
(60) Provisional application No. 61/086,917, filed on Aug. 7, 2008.

(51) Int. Cl. G06F 12/16

(52) U.S. Cl. 711/114; 711/E12.103

(57) ABSTRACT

The present disclosure relates to a data storage system including a RAID subsystem having a first and second type of RAID storage. A virtual volume configured to accept I/O is stored on the first type of RAID storage, and snapshots of the virtual volume are stored on the second type of RAID storage. A method of the present disclosure includes providing an active volume that accepts I/O and generating read-only snapshots of the volume. In certain embodiments, the active volume is converted to a snapshot. The active volume includes a first type of RAID storage, and the snapshots include a second type of RAID storage. The first type of RAID storage has a lower write penalty than the second type of RAID storage. In typical embodiments, the first type of RAID storage includes RAID 10 storage and the second type of RAID storage includes RAID 5 and/or RAID 6 storage.

### FIELD OF THE INVENTION

The present disclosure relates to a system and method for transferring data between different RAID data storage types in a data storage system. More particularly, the present disclosure relates to a system and method for transferring data between different RAID data storage types for current data and replay data.

### BACKGROUND OF THE INVENTION

RAID storage is commonly used in current data storage systems or storage area networks (SAN). Many different levels of RAID exist, including RAID 0, RAID 1, RAID 3, RAID 4, RAID 5, RAID 6, RAID 10, etc.

RAID 5, for example, may use block-level striping with parity data distributed across all member disks. Generally, if data is written to a data block in a RAID 5 stripe, the parity block (P) must also be recalculated and rewritten. This requires calculating and writing the new parity to the parity block and writing the new data to the data block. This may also require reading the old data from the data block. Therefore, RAID 5 writes are relatively expensive in terms of disk operations and communication between the disks and a RAID controller.

The parity blocks are read when a read of a data block results in an error. Each of the remaining data blocks and the parity block in the RAID 5 stripe are used to reconstruct the data in the data block for which the read error occurred. Should an entire disk fail in the disk array, the distributed parity blocks from the live disks are combined mathematically (i.e., exclusive OR) with the data blocks from the live disks to reconstruct the data on the failed drive.

RAID 6, from one perspective, improves RAID 5 configurations by adding an additional parity block (Q). It uses block-level striping with two parity blocks (P and Q) distributed across all member disks. Thus, RAID 6 provides protection against double disk failures, e.g., failures while a failed disk is being reconstructed. When a read of a single data block results in an error, one of the parity blocks (P) can be used to reconstruct the data in the data block. When a read of two data blocks each result in an error, both parity blocks (P and Q) are used to reconstruct the data in the data block.

Partial stripe write requests for RAID 5 and RAID 6 levels are relatively inefficient due to the need to perform read-modify-write operations to update the data and parity blocks (P for RAID 5 or P and Q for RAID 6). Therefore, RAID 5 and RAID 6 configurations generally suffer from poor performance when faced with a workload that includes many writes.

When no disks have failed, during read operations in RAID 5 and RAID 6 configurations, the parity blocks are not read. The read performances of RAID 5 and RAID 6 are generally similar to other RAID levels, such as RAID 0.

RAID 10, on the other hand, does not have the write penalty demonstrated by RAID 5 and RAID 6 levels. RAID 10 is often used for high-load databases because the lack of a parity block allows RAID 10 to have faster write speeds. RAID 10 is a particular combination of two different RAID levels—RAID 1 and RAID 0. RAID 10 is appealing because RAID 1 provides a high level of availability and RAID 0 provides the highest performance. However, RAID 5 and RAID 6 have substantially greater storage efficiency than RAID 10.

Thus, there is a need in the art for a system and method for transferring data between different RAID data storage types in a data storage system. There is a further need in the art for a system and method for transferring data between different RAID data storage types for current data and replay data. There is a similar need in the art for a system and method for transferring data between RAID 5 and/or RAID 6 levels and RAID 10 levels where the advantages of each RAID configuration can be utilized when most desirable.

### BRIEF SUMMARY OF THE INVENTION

The present disclosure, in one embodiment, relates to a method for transferring data between data storage types of a RAID storage system. The method includes providing an active volume of data storage space that accepts read and write requests and generating a read-only snapshot of the active volume. In certain embodiments, the active volume is converted to the read-only snapshot. The active volume includes a first type of RAID storage, and the snapshot includes a second type of RAID storage. The first type of RAID storage has a lower write penalty than the second type of RAID storage. In typical embodiments, the first type of RAID storage includes RAID 10 storage and the second type of RAID storage includes RAID 5 and/or RAID 6 storage.

The methods of the present disclosure, in further embodiments, include generating a view volume of the read-only snapshot data. The view volume can accept read and write requests. Therefore, the view volume includes a type of RAID storage that has a lower write penalty than the type of RAID storage used for the read-only snapshot data. In certain embodiments, the view volume includes RAID 10 storage.

The present disclosure, in another embodiment, relates to a data storage system including a RAID subsystem having a first and second type of RAID storage. The data storage system further includes a virtual volume, stored on the first type of RAID storage, configured to accept I/O and one or more snapshots of the virtual volume stored on the second type of RAID storage. The first type of RAID storage has a lower write penalty than the second type of RAID storage.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the present invention, it is believed that the invention will be better understood from the following description taken in conjunction with the accompanying Figures, in which:

FIG. 1 is a schematic view of snapshots of a data storage structure at a plurality of exemplary time intervals in accordance with one embodiment of the present disclosure.

FIG. 2 is a flow diagram of a PITC life cycle in accordance with one embodiment of the present disclosure.

### DETAILED DESCRIPTION

The present disclosure relates to a system and method for transferring data between different RAID data storage types in a data storage system. More particularly, the present disclosure relates to a system and method for transferring data between different RAID data storage types for current data and replay data. Furthermore, the present disclosure relates to a system and method for transferring data between RAID 5 and/or RAID 6 levels and RAID 10 levels where the advantages of each RAID configuration can be utilized when most desirable.

The embodiments of the present disclosure may be used with any suitable data storage system or SAN. In one embodiment, the systems and methods of the present disclosure may be used with a data storage system such as that disclosed in U.S. patent application Ser. No. 10/918,329, filed Aug. 13, 2004, entitled Virtual Disk Drive System and Method, and published on Mar. 10, 2005 under U.S. Publication No. 2005/0055603, the entirety of which is hereby incorporated by reference herein. U.S. patent application Ser. No. 10/918,329 discloses an improved disk drive system that allows dynamic data allocation and disk drive virtualization. The disk drive system may include a RAID subsystem, having a page pool of storage that maintains a free list of RAIDs or a matrix of disk storage blocks, and a disk manager having at least one disk storage system controller. The RAID subsystem and disk manager may dynamically allocate data across the page pool of storage or the matrix of disk storage blocks and a plurality of disk drives based on RAID-to-disk mapping. A disk drive system, such as that described in U.S. application Ser. No. 10/918,329, may include dynamic data allocation and snapshot functions to allow efficient data storage of Point-In-Time Copies (PITCs) of a virtual volume matrix or pool of disk storage blocks, instant data fusion and data instant replay for data backup, recovery, testing, etc., remote data storage, and data progression, etc., each of which is described in detail in U.S. application Ser. No. 10/918,329.

New systems and methods, disclosed herein, provide features that have previously been unattained in data storage systems. For example, data may be stored in different RAID levels for different types of data, such as current data or replay/backup data. In one embodiment, data stored in RAID 5 and/or RAID 6 levels may be transferred to RAID 10 levels, or vice versa, at appropriate times where the advantages of each RAID configuration can be utilized most efficiently. Particularly, RAID 5 and/or RAID 6 storage may be generally used for read-only data, as RAID 5 and RAID 6 levels are generally efficient for read operations but disadvantageously include a penalty for write operations. RAID 5 and RAID 6 also advantageously provide relatively good data protection. RAID 10 storage may be generally used for both reading and writing data, as RAID 10 storage is relatively efficient in both reading and writing operations. However, RAID 5 and RAID 6 have substantially greater storage efficiency than RAID 10, as shown, for exemplary purposes only, below.

Supports Relatively Good Read and Write Performance:
Raid 10, single mirror is 50% space efficient and supports any single drive failure.
Raid 10, dual mirror is 33% space efficient and supports any dual drive failure.

Supports Relatively Good Read Performance:
Raid 5, five wide is 80% space efficient and supports any single drive failure.
Raid 5, 9 wide is 89% space efficient and supports any single drive failure.
Raid 6, six wide is 67% space efficient and supports any dual drive failure.
Raid 6, ten wide is 80% space efficient and supports any dual drive failure.

In one embodiment, when data is committed as read-only, it may be transferred or moved from RAID 10 storage to RAID 5 and/or RAID 6 storage. In some embodiments, RAID 10 storage may be used for current data while RAID 5 and/or RAID 6 storage may be used for replay data. In a further embodiment, the majority of the data in a storage system may be stored in RAID 5 and/or RAID 6 storage.

In one embodiment, data instant fusion methods, as described in U.S. application Ser. No. 10/918,329, may automatically generate PITCs of a RAID subsystem at user defined time intervals, user configured dynamic time stamps, e.g., every few minutes or hours, etc., or at times or time intervals directed by the server. In case of a system failure or virus attack, these time-stamped virtual PITCs may allow data instant replay and data instant recovery, as described in U.S. application Ser. No. 10/918,329, in a matter of a few minutes or hours, etc. That is, the data shortly before the crash or attack may be fused in time, and the PITCs stored before the crash or attack can be instantly used, or instantly replayed, for future operation.

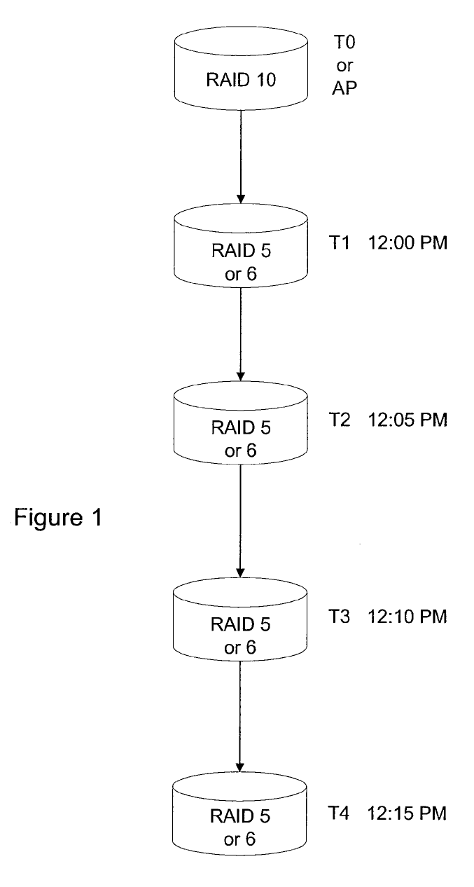

As shown in FIG. 1, at each predetermined time interval, e.g., five minutes, such as T1 (12:00 PM), T2 (12:05 PM), T3 (12:10 PM), and T4 (12:15 PM), a PITC of the page pool of storage, the matrix of disk storage blocks, or any other suitable data storage structure, e.g., the active PITC further described in detail below, may be automatically generated. The address indexes of the PITCs or deltas in the page pool of storage, matrix of the disk storage blocks, or other suitable data storage structure in any suitable data storage system or SAN may be stored in the page pool of storage, matrix of the disk storage blocks, or other suitable data storage structure such that the PITCs or deltas of the page pool of storage, matrix of the disk storage blocks, or other suitable data storage structure can be instantly located via the stored address indexes. The PITCs can be stored at a local RAID subsystem or at a remote RAID subsystem, so that if a major system crash occurs, for example due to a building fire, the integrity of the data is not affected, and the data can be instantly recovered or replayed. Any suitable or desirable RAID level may be used to store fused or PITC data. In one embodiment, the PITCs may be stored in RAID 5 and/or RAID 6 storage levels, so that the data receives the data protection that RAID 5 and/or RAID 6 levels provide.

Another feature of instant data fusion and data instant replay is that the PITCs can be used for testing while the system remains in operation. In other words, real data can be used for real-time testing. In some embodiments, as detailed below, PITC data may be transferred to RAID 10 storage for testing (e.g., view volumes, as described below, may be created on RAID 10 storage using the PITC data stored in RAID 5 and/or RAID 6 storage). In other embodiments, the PITC data may remain in RAID 5 and/or RAID 6 storage for testing (e.g., view volumes, as described below, may be created on RAID 5 and/or RAID 6 storage).

A volume using snapshot may behave substantially the same as a volume without snapshot. In one embodiment, the top-level PITC for a volume may be called the active PITC (AP). The AP may satisfy all read and write requests to the volume. In one embodiment, the AP may be the only PITC for the volume that accepts write requests. The AP may also contain a summary of the current location of all the data within the volume. In one embodiment, the AP may track only the difference between the previous PITC and the current, top-level PITC, or AP. For example, the AP may track only the writes to the volume.

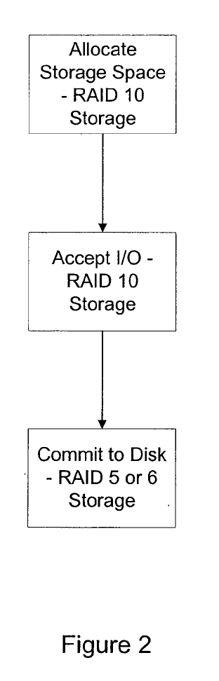

In one embodiment of a PITC life cycle, as illustrated in FIG. 2, a top-level PITC, or AP, may go through a number of following states before it is committed as read-only. As previously stated, a PITC may be stored at one RAID level and then transferred to another RAID level when desirable. In one embodiment, a PITC may be stored in RAID 10 storage while it is able to accept writes to the volume and may be stored in RAID 5 and/or RAID 6 after it is committed to read-only. Thus, the PITC may receive the advantages of RAID 10 associated with write operations and avoid the disadvantages of RAID 5 and/or RAID 6 associated with write operations while also receiving the data protection that RAID 5 and/or RAID 6 offer for read-only data. A typical life cycle of a top-level PITC may comprise one or more of the following states:
1. Allocate Storage Space—Storage space may be dynamically generated on the disk for the PITC. Writing the table at this point may guarantee that the required space to store the table information is allocated before the PITC is taken. At the same time, the PITC object may also be committed to the disk. Although any suitable RAID level may be used to store the PITC, in one embodiment, RAID 10 storage may be used.
2. Accept I/O—The PITC may become the AP. It may now handle read and write requests for the volume. In one embodiment, this may be the only state that accepts write requests to the table. The PITC may generate an event that it is now the AP. As previously described, RAID 10 storage may be used while the PITC is the AP. RAID 10 is appealing because it provides a high level of availability and high performance and does not suffer from the write penalties associated with some other RAID levels, such as RAID 5 or RAID 6.
3. Commit to Disk as Read-Only—The PITC is no longer the AP, and may no longer accept additional pages. A new AP has taken over, and the PITC may now be read-only. After this point, in one embodiment, the table may not change unless it is removed during a coalesce operation. The PITC may further generate an event that it is frozen and committed. Any service may listen to the event. In one embodiment, when a PITC is no longer the AP and becomes read-only, the data associated with the PITC may be transferred from RAID 10 storage to RAID 5 and/or RAID 6 storage. As previously described, RAID 5 and RAID 6 may, in some cases, offer more efficient protection of the data as data can be recovered after read errors or failed disks. Since the PITC has become read-only, the write penalties of RAID 5 and/or RAID 6 can be minimized or eliminated.

Instant data fusion and data instant replay may further be used, in one embodiment, to utilize PITCs of disk storage blocks of a RAID subsystem for more than backup or recovery operations. In one embodiment, a PITC may record write operations to a volume while it is the AP so that a “view” may be created from the PITC to see the contents of a volume as they were in the past. That is, snapshot may support data recovery or other functions by creating views to a previous PITC of a volume. View volumes may provide access to the data of previous PITCs and may support normal volume I/O operations, including read and write operations. In one embodiment, view volume functions may attach to any PITC within the volume. In a further embodiment, a view taken from the current state of the volume may be copied from the current volume AP. Attaching to a PITC can be a relatively quick operation, and in some embodiments, view volume creation may occur nearly instantaneous and may require no data copies. In one embodiment, the view volume may allocate space from the parent volume. Deleting the view volume may free the space back to the parent volume. In some embodiments, as detailed below, views or view volumes of previous PITCs may be done using RAID 5 and/or RAID 6 storage. Alternatively, views or view volumes may be created using RAID 10 storage from PITC data stored in the RAID 5 and/or RAID 6 storage. Exemplary uses of view volume functions may include testing, training, backup, and recovery.

In one embodiment, a view or view volume may contain its own AP to record writes to the PITC. Using the AP, the view volume may allow write operations to the view volume without modifying the underlying volume data. A single volume may support multiple child view volumes.

In one embodiment, a PITC may be stored in one or more RAID levels, and a view volume for the PITC may be created in storage of the same RAID levels. For example, the PITC may be stored in RAID 5 and/or RAID 6 storage levels, and a view volume for the PITC may also be created using RAID 5 and/or RAID 6 storage. In a further embodiment, a PITC may be stored in one or more RAID levels, and a view volume for the PITC may be created in storage of one or more different RAID levels. For example, the PITC may be stored in RAID 5 and/or RAID 6 storage levels, and a view volume for the PITC may be created using RAID 10 storage. As such, the PITC may retain the data protection that RAID 5 and RAID 6 provide, and the view volume, which may accept write operations, may avoid the write penalty associated with RAID 5 and RAID 6 storage.

Although the present invention has been described with reference to preferred embodiments, persons skilled in the art will recognize that changes may be made in form and detail without departing from the spirit and scope of the invention. For example, although embodiments have been described above with respect to RAID 5, RAID 6, and RAID 10 storage, data may be transferred between any suitable levels of RAID storage at times where the advantages of each RAID level may be appropriately utilized. Additionally, although embodiments have been described as storing read-only data in RAID 5 and/or RAID 6 storage, the data need not be read-only. In some embodiments, the data may accept both read and write operations. Although, in some embodiments, the write operations may comprise a substantially smaller portion of the operations than the read operations and therefore, the write penalties associated with RAID 5 and/or RAID 6 can still be minimized.

We claim:

1. A method for transferring data between data storage types of a RAID storage system comprising:
providing an active volume of data storage space that accepts I/O; and
generating a read-only snapshot of the active volume;
wherein the active volume comprises a first type of RAID storage and the snapshot comprises a second type of RAID storage.

2. The method of claim 1, wherein the second type of RAID storage comprises at least one of RAID 5 or RAID 6 storage.

3. The method of claim 1, wherein the first type of RAID storage comprises RAID 10 storage.

4. The method of claim 3, wherein the second type of RAID storage comprises at least one of RAID 5 or RAID 6 storage.

5. The method of claim 1, further comprising generating a view volume of the read-only snapshot that may accept I/O.

6. The method of claim 5, wherein the view volume comprises a third type of RAID storage.

7. The method of claim 6, wherein the third type of RAID storage is the same as the first type of RAID storage.

8. A method of transferring data between data storage types of a RAID storage system comprising:
providing an active volume comprising a first type of RAID storage, the active volume configured to accept I/O;
converting the active volume to a read-only Point-In-Time Copy of the active volume;
wherein converting the active volume to a read-only Point-In-Time Copy comprises transferring the data from the first type of RAID storage to a second type of RAID storage.

9. The method of claim 8, wherein the first type of RAID storage has a lower write penalty than the second type of RAID storage.

10. The method of claim 9, wherein the second type of RAID storage comprises at least one of RAID 5 or RAID 6 storage.

11. The method of claim 9, wherein the first type of RAID storage comprises RAID 10 storage.

12. The method of claim 11, wherein the second type of RAID storage comprises at least one of RAID 5 or RAID 6 storage.

13. The method of claim 11, further comprising generating a view volume of the read-only snapshot that may accept I/O, wherein the view volume comprises the first type of RAID storage.

14. A data storage system comprising:
a RAID subsystem comprising a first and second type of RAID storage;
a virtual volume configured to accept I/O, the virtual volume stored on the first type of RAID storage;
one or more snapshots of the virtual volume stored on the second type of RAID storage.

15. The data storage system of claim 14, wherein the first type of RAID storage has a lower write penalty than the second type of RAID storage.

16. The data storage system of claim 15, wherein the second type of RAID storage comprises at least one of RAID 5 or RAID 6 storage.

17. The data storage system of claim 15, wherein the first type of RAID storage comprises RAID 10 storage.

18. The method of claim 17, wherein the second type of RAID storage comprises at least one of RAID 5 or RAID 6 storage.
